(19) United States
(12) Patent Application Publication
(10) Pub. No.: US 2003/0058266 A1
(43) Pub. Date: Mar. 27, 2003

(54) Hot linked help

(76) Inventors: Kendra L. Dunlap, Tigard, OR (US); Dellas G. Frederiksen, Boise, ID (US); Dustin C. Rosing, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 09/967,303

(22) Filed: Sep. 27, 2001

(51) Int. Cl. G09G 5/00

(52) U.S. Cl. 345/705

(57) ABSTRACT

A method and apparatus for providing user instructions or help information to a user of a computer controlled multi-function office device that enables the user to access a help module with an icon-based help mode configured to allow the user to select an icon and get an identification of the function, which the icon performs without performing the function. In accordance with the invention the identification of the function includes a link to instructions that explain the steps to use the function associated with the selected icon.

### FIELD OF THE INVENTION

The present invention generally relates to a method and apparatus for accessing help functions, and more particularly to a system for accessing help instructions through command icons on a graphical user interface.

### BACKGROUND OF THE INVENTION

Office devices have increased the efficiency of the modem office and increased the productivity of office staffs, through an increase in the functions that these devices can perform. These technical advances in office devices, however, have lead to increased complexity in the operations of these devices. One method for simplifying the controls for devices with numerous functions has been the introduction of graphical user interfaces that use icons to represent a command or group of commands. One problem resulting from these icon interfaces is that the user may have difficulty learning what function, or functions, each icon represents and hence have trouble operating these devices. To address this, “help” functions often have been incorporated into the graphical user interface on the device to explain the functions of each of the icons.

Traditional “help” systems have functioned using one of two methods, a graphical descriptor window, or a topical index display. The first method, the graphical descriptor window, is a help mode in which the user selects an icon, and a graphical descriptor window appears in response to the user-selection. A short description of the function, or functions, associated with that icon is contained within the window. This is of some help, but does not give the user detailed step-by-step information about the function, or functions, associated with the selected icon. The second method, the topical index display mode, displays for the user a list of topics related to the functions that the device is capable of performing, usually organized alphabetically, and the user selects a topic from the list and gets detailed step-by-step instructions on how to perform the various functions associated with the selected topic.

The two traditional help modes fail to quickly communicate to the user the detailed step-by-step instructions associated with an icon. To access both the short description and the detailed step-by-step instructions, the user must complete multiple steps. First, the user must enter the first mode and get the short description information on what icon performs what functions, then exit the first mode. Next, the user must enter the second mode to get the detailed step-by-step instructions related to each function of interest. This is an overly cumbersome “help” system.

It would be desirable to provide a help system that combined the two functions in a simple-to-use interface where the user may access both the short description of the graphical descriptor window and the detailed step-by-step instructions that relate to the functions of a particular icon in one simple-to-use interface, or user environment.

### SUMMARY OF THE INVENTION

The present invention is a method and apparatus for providing user instructions, or help information, for a computer-controlled, multi-function office device. Using the present invention the user may access a help module with an icon-based help mode configured to allow the user to select an icon to provide an identification of the function, which the icon performs without performing the function. In accordance with the invention, the identification of the function includes a link to step-by-step instructions that explain the steps to use the function associated with the selected icon.

### BRIEF DESCRIPTION OF THE FIGURES

FIG. 1 is a schematic representation of a device configured to employ the present invention.

FIG. 2 is a flow chart showing the operation of a help module according to the present invention.

FIG. 3 is a representation of a screen displaying a graphical user interface according to an embodiment of the present invention, showing the operation screen mode.

FIG. 4 is a representation of the screen of FIG. 3, after user-selection of the help module.

FIG. 5 is a representation of the screen of FIG. 3, after selection of the “What is this?” help mode, showing a temporary message screen indicting that the user has entered the “What is this?” help mode.

FIG. 6 is a representation of the screen of FIG. 3 after selection of an icon, showing a “What is this?” help window with an identification of the function associated with the icon, and a link to step-by-step instructions.

FIG. 7 is a representation of a screen showing step-by-step instructions relating to a selected function.

FIG. 8 is a representation of a screen showing a list of help topics.

### DETAILED DESCRIPTION OF THE INVENTION

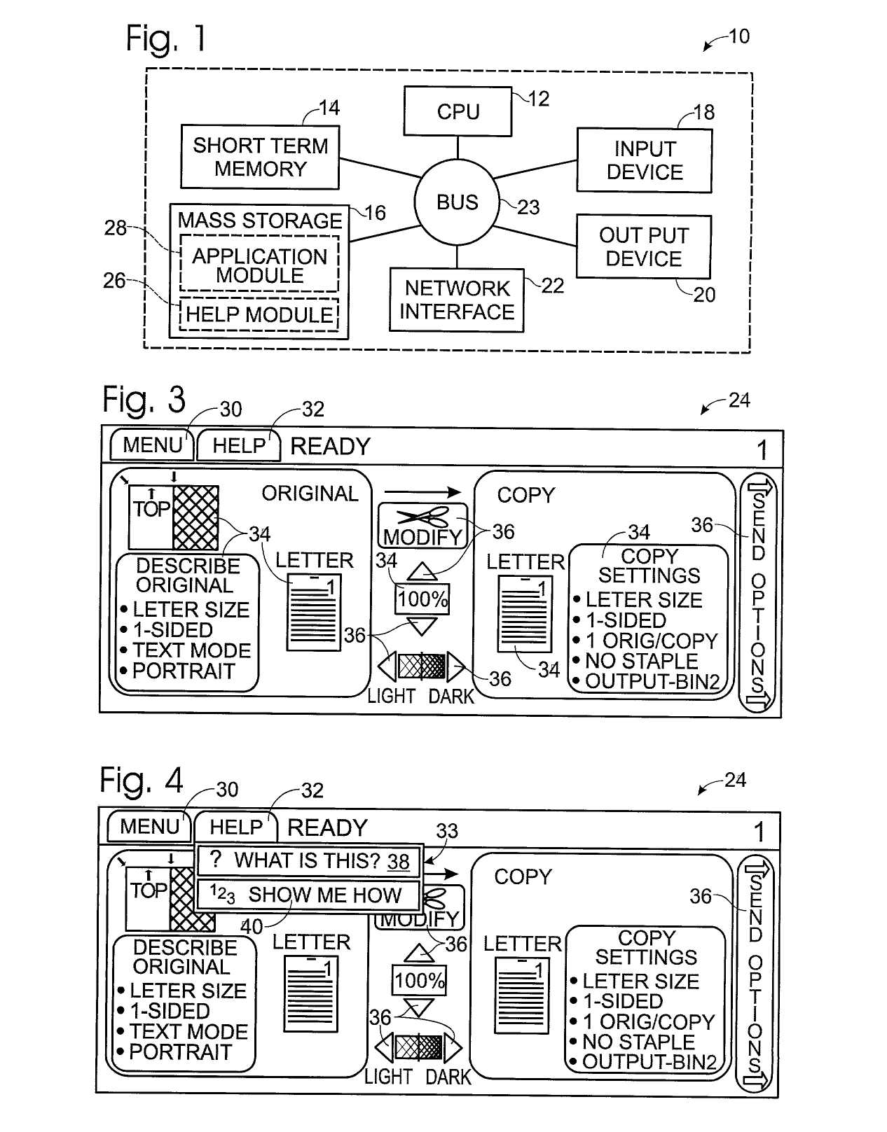

Referring initially to FIG. 1, a device for implementing the method of the present invention is generally indicated at 10. Device 10 includes a central processing unit (CPU) 12, short-term memory 14, mass storage media 16, a user input device 18, an output device 20, a network interface 22, and a bus 23. User input device 18 and output device 20 are configured to enable a graphical user interface 24, such as that illustrated in FIG. 3.

Graphical user interface 24 may be implemented with a touch-sensitive display, or some other display and pointing device combination, such as a monitor and mouse. It will thus be appreciated that device 10 may be any device or apparatus for handling information, including but not limited to digital networked office copiers, multi-function peripherals (MFP), computers, fax machines, printers, digital senders, etc.

A help module 26 and an application module 28 reside on mass storage media 16 of device 10. It will be appreciated that the help module may be independent of the application module, or may form a part of the application module. It also will be appreciated, that the application module may be present on mass storage media 16 or otherwise accessible by CPU 12. CPU 12 runs application module 28 using bus 23, memory 14, output device 20 and user input device 18.

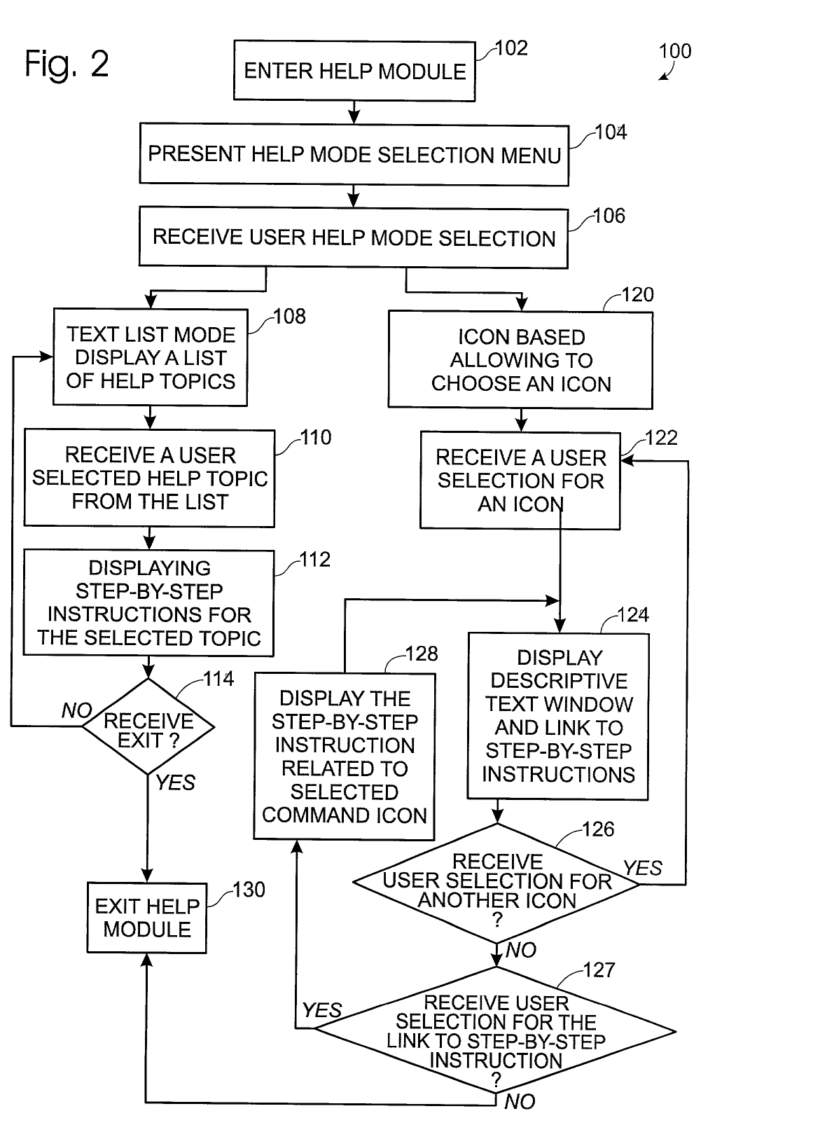

Application module 28 is configured for use in an environment such as that of graphical user interface 24. Application module 28 allows a user to access help module 26 in order to obtain help information related to the functions of device 10. Application functions appear as graphical user interface elements, or icons, on graphical user interface 24. A flow chart of the steps employed by help module 26 is shown in FIG. 2 and will be discussed in detail below.

By way of illustration FIGS. 3-8 show an embodiment of the present invention in the context of a multi-function peripheral. It should be understood that other devices and functions are within the scope of the present invention.

In the present illustration graphical user interface 24 takes the form of a touch-screen display as shown in FIG. 3. User interface 24, shown schematically, includes menu button 30, help button 32, a variety of informational icons 34, and a variety of command icons 36. Informational icons display status information relating to the application module and may be configured to actuate functions related to application module 28 and device 10. Command icons 36 actuate functions associated with application module 28 and device 10. As noted above, the illustrated example includes MFP/copier information icons and command icons, such as original size, modify, reduce/enlarge, and lighten/darken. However, any suitable set of informational and command icons may be used, dependent upon the context.

The user selects help button 32 from graphical user interface 24 to cause application module 28 to access help module 26. Upon accessing the help module, a pull down menu 33 appears, as shown in FIG. 4. Pull down menu 33 includes two modes of help. A “What is this?” help mode is selectable by “What is this?” button 38 and a “Show me how” help mode is selectable by “Show me how” button 40, both on pull down menu 33.

The “What is this?” mode button activates the “What is this,” or icon-based, help mode. This help mode allows the user to select information icons 34 and/or command icons 36 on graphical user interface 24 without invoking the function, or functions, associated with the icons.

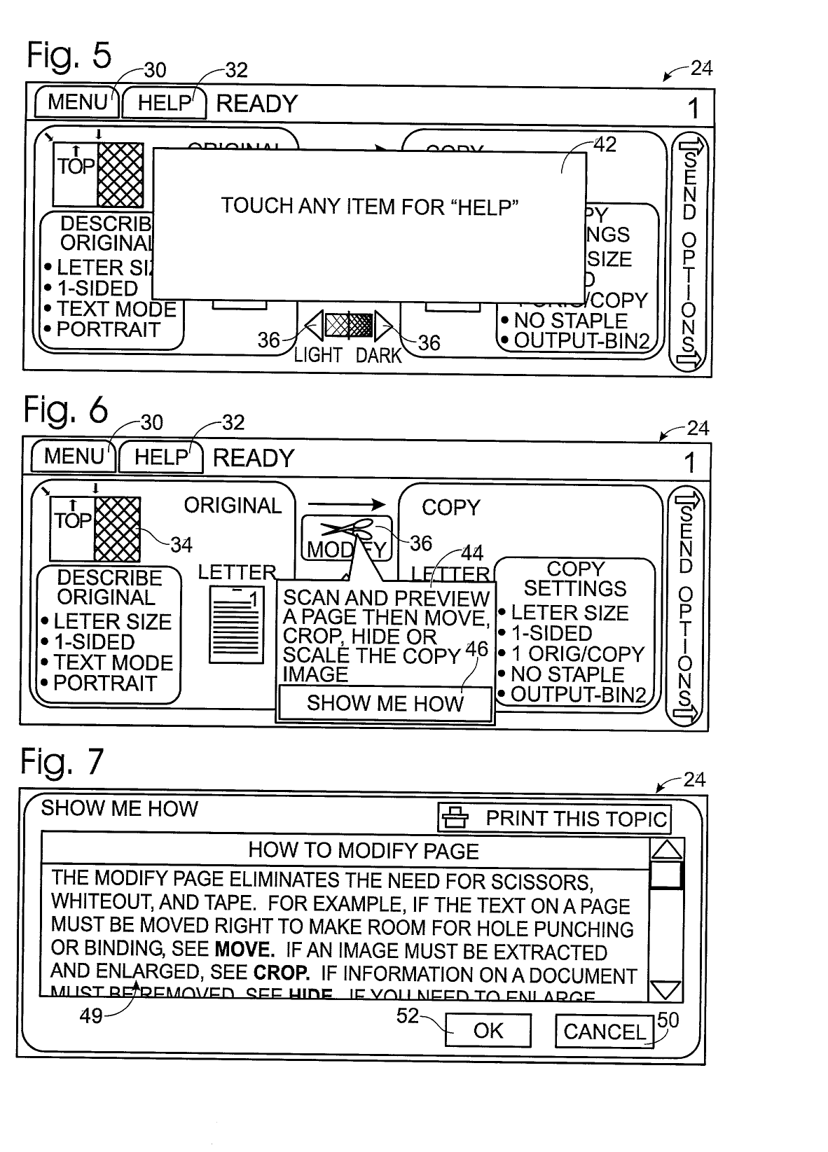

When the user selects “What is this?” mode button 38 a communication window 42 temporarily appears, indicating that the user may touch any item for ‘Help’. Communication window 42 is shown in FIG. 5. Communication window 42 lets the user know that selection of either information icons 34 or command icons 36 will not invoke the function associated with the selected icon.

Referring to FIG. 6, it will be appreciated that following the user-selection of an icon a “What is this?” help window 44 appears. Window 44 contains an identification of the function associated with the selected icon, and includes a “Show Me How” button 46. “Show Me How” button 46 links the user to step-by-step instructions related to the function described in “What is this?” help window 44. Window 44 displays information, typically text, identifying the function associated with the user-selected icon 36.

By way of example, as shown in FIG. 6, the “modify” command icon has been selected and “What is this?” help window 44 contains a text description and “Show Me How” button 46. When the user selects “Show Me How” button 46, graphical user interface 24 will present the user with detailed step-by-step command instructions 49 related to the function associated with the user-selected command icon 36. By way of example, detailed step-by-step instructions are illustrated in FIG. 7 at 49. The step-by-step command instructions convey to the user what series of steps they need to execute in order to accomplish a task associated with the function. A task may be a subset of a function. For example, a function to modify may include the tasks of cropping, rotating, resizing, etc.

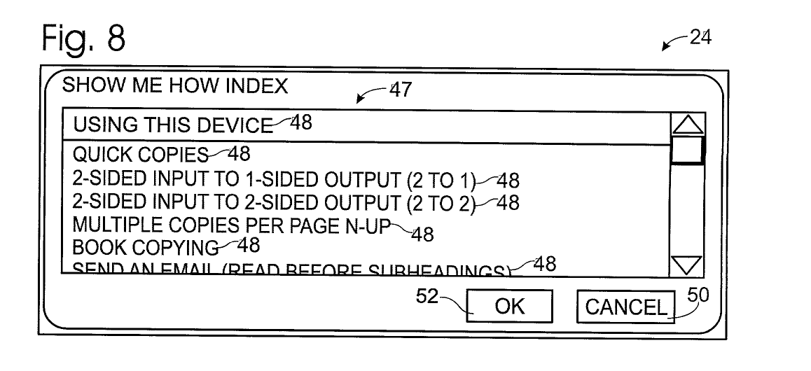

Returning to FIG. 4, by contrast, when the user selects the “Show me how” button from pull-down menu 33, a “Show me how” index list 47 is presented as shown in FIG. 8. Index list 47 includes a list of help topics 48, as also shown in FIG. 8. The user may select one help topic from index list 47. Upon selection of a help topic the user receives step-by-step instructions 49 related to the user-selected help topic. FIG. 7 shows an example of step-by-step instructions 49 presented to the user.

When graphical user interface 24 is displaying either index list 47 or step-by-step instructions 49 a “cancel” button 50 and an “OK” button 52 are also presented. Irrespective of the process by which user interface 24 arrives at either of these screens, the user may exit help module 26 by selecting “cancel” button 50. In contrast, the user may return to the prior screen, whatever that prior screen may have been, by selecting “OK.” button 52. That is to say, if user-interface 24 was in the “What is this?” (or icon-based) help mode the interface would return to the previous screen, showing help window 44 for the most recently user-selected icon 34 or 36. If the user interface 24 happened to be in the “Show Me How” help mode the interface would return to the previous screen displaying help index list 47.

The method employed by help module 26 is shown by flow chart 100 of FIG. 2. At 102 the module receives a call for help. Upon receipt of the call for help a pull down menu displaying the two help modes is presented on the user interface, as indicated at 104. The help module then receives a selection of the mode of help, as shown at 106. If the selection is for an index list help mode (or “Show Me How” help mode) the graphical user interface displays an index list of help topics as shown at 108. If the help module receives a selection for an icon-based help mode (or “What is this?” help mode) then the help module allows the user to choose an icon as indicated at 120.

Starting with the help module 26 receiving an index list help mode selection and proceeding to step 108, the module then receives a user selection for a help topic from the index list displayed as indicated at 110. Next the user interface displays step-by-step instructions for the selected topic as shown at 112. At 114 the user is presented the choice of returning to the index list of help topics or exiting help module 26. If the user selects exiting the module proceeds to step 130. However, if the user selects retuning to the list of help topics help module 26 returns to step 108.

If, at step 106, the user selects the icon-based help mode (or “What is this?” help mode), help module 26 allows the user to choose an icon as indicated at 120. The user may choose any of the information icons 34 or command icons 36, as shown in FIGS. 4-7. At 122, the help module receives a user-selection for an icon. Next, the help module displays a descriptive text window containing an identification of the function which the selected icon performs and a link to step-by-step instructions, as indicated at 124. The help module then checks for receipt of a user selection of another icon, as indicated at 126. If the help module does not receive a selection of another icon, it checks for a user selection of the link for step-by-step instructions, as indicated at 127. If the module receives a user selection of the link to step-by-step instructions, the module proceeds to step 128. At step 128, the module displays step-by-step instructions related to the selected icon. If at step 127 there is no selection of the link to step-by-step instructions the help module exits, as indicated at step 130.

It should be understood that while the preceding method description focused on the implementation of the present invention in the context of a multi-function peripheral, a person of ordinary skill in the art would understand that this kind of help system could be employed by any number of devices that handle data and document processing.

While the present invention has been particularly shown and described with reference to the foregoing preferred embodiments, those skilled in the art will understand that many variations may be made therein without departing from the spirit and scope of the invention as defined in the following claims. The description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this, or a later application. Where the claims recite “a” or “a first” element or the equivalent thereof, such claims should be understood to include incorporation of one or more such elements, neither requiring nor excluding two or more such elements.

We claim:

1. A method for accessing instructions on a device having a user interface, the method comprising the steps of:
receiving a user-selection of a first help mode displayed on the user interface, the selected first help mode allowing the user to choose an icon for identification of a function associated with the icon without invoking the function;
upon receiving a user-selection of the icon, displaying a help window including an identification of a function associated with the icon and a link to instructions related to accomplishing the function; and
in response to user-selection of the link, displaying the instructions related to accomplishing the function.

2. The method of claim 1, which further comprises returning to the first help mode on the user interface after displaying the instructions,
receiving a next selection of a different icon
displaying a different help window including an identification of a next function associated with the different icon and a next link to instructions related to accomplishing the next function; and
in response to user-selection of the next link, displaying instructions related to accomplishing the next function.

3. The method of claim 1, wherein the identification of a function associated with the icon includes a description of the function.

4. The method of claim 1, wherein the instructions related to accomplishing the function include a series of steps a user executes to accomplish a task associated with the function.

5. The method of claim 1, further comprising the steps of:
receiving a user-selection of a second help mode displayed on the interface, the second help mode presenting a user with a list of help topics;
receiving a user-selection for a help topic from the list; and
displaying instructions for accomplishing a function related to the user-selected help topic.

6. A device configured to perform one or more user-selectable functions, the device comprising:
a processor configured to nominally effect a function upon receiving a command associated with the function; and
a user interface including a plurality of selectable icons, selection of each icon nominally effecting transmission of a corresponding command to the processor, the user interface further including a help menu having a user-selectable first help mode which provides for subsequent selection of icons without transmission of the corresponding command to the processor, and a help window presented upon selection of an icon after selection of the first help mode, the help window including an identification of a function associated with the selected icon and a link to command instructions related to the function associated with the selected icon, selection of the link effecting communication of the instructions.

7. The device of claim 6, further comprising a user-selectable second help mode, which upon selection, presents the user with a list of help topics from which the user selects a topic, wherein upon selection of a topic a set of instructions associated with the selected topic is displayed.

8. The device of claim 7, wherein the user interface includes a touch screen, which accommodates user-selection of the help menu and subsequently user-selection of either of the first help mode and the second help mode.

9. The device of claim 8, wherein the device is a copier.

10. The device of claim 8, wherein the device is a printer.

11. The device of claim 8, wherein the device is a fax machine.

12. The device of claim 8, wherein the device is a digital sender.

13. The device of claim 8, wherein the device is a multi-function peripheral

14. A computer-implemented user interface comprising:
plural icons, each nominally selectable to invoke a function associated with the icon;
a help menu including a first help mode selectable to provide for subsequent selection of one of the icons without invoking the function associated with the selected icon;
a help window presented upon selection of the first help mode and subsequent selection of the selected icon, the help window including an identification of the function associated with the selected icon and a link to command instructions related to the function associated with the selected icon; and
command instructions presented upon selection of the link.

15. The interface of claim 14, wherein the help menu includes a second help mode configured to presents a list of selectable help topics, which upon selection of one of the help topics presents instructions related to the selected topic.

16. The interface of claim 15, wherein interface is configured to operate a printer.

17. The interface of claim 15, wherein the interface is configured to operate a copier.

18. The interface of claim 15, wherein the interface is configured to operate a fax machine.

19. The interface of claim 15, wherein the interface is configured to operate a digital sender.

20. The interface of claim 15, wherein the interface is configured to operate a multi-function peripheral.

21. A program storage device readable by a processor, tangibly embodying a program of instructions executable by the processor to perform method steps for accessing instructions on a device having a user interface, the method steps comprising:
receiving a user-selection of a first help mode displayed on the user interface, the selected first help mode allowing the user to choose an icon for identification of a function associated with the icon without invoking the function;
upon receiving a user-selection of the icon, displaying a help window including an identification of a function associated with the icon and a link to instructions related to accomplishing the function; and
in response to user-selection of the link, displaying the instructions related to accomplishing the function.

22. The program storage device of claim 21, wherein the method further comprises:
returning to the first help mode on the user interface after displaying the instructions,
receiving a next selection of a different icon
displaying a different help window including an identification of a next function associated with the different icon and a next link to instructions related to accomplishing the next function; and
in response to user-selection of the next link, displaying instructions related to accomplishing the next function.

23. The program storage device of claim 21, wherein the method further comprises:
receiving a user-selection of a second help mode displayed on the interface, the second help mode presenting a user with a list of help topics;
receiving a user-selection for a help topic from the list; and
displaying instructions for accomplishing a function related to the user-selected help topic.
